(19) United States
(12) Patent Application Publication
(10) Pub. No.: US 2015/0134460 A1
(43) Pub. Date: May 14, 2015

(54) METHOD AND APPARATUS FOR SELECTING AN ADVERTISEMENT FOR DISPLAY ON A DIGITAL SIGN

(71) Applicants: Fengzhan Phil Tian, Zhongguancun (CN); Addicam Sanjay Sanjay, Gilbert, AZ (US); Kunapareddy Chiranjeevi, Ameerpet (IN); Shweta Phadnis, Chandler, AZ (US); Shahzad Malik, Markham (CA)

(72) Inventors: Fengzhan Phil Tian, Zhongguancun (CN); Addicam Sanjay Sanjay, Gilbert, AZ (US); Kunapareddy Chiranjeevi, Ameerpet (IN); Shweta Phadnis, Chandler, AZ (US); Shahzad Malik, Markham (CA)

(21) Appl. No.: 13/634,143

(22) PCT Filed: Jun. 29, 2012
(86) PCT No.: PCT/CN2012/077909

§ 371 Date: Mar. 12, 2013

(51) Int. Cl. G06Q 30/02

(52) U.S. Cl. CPC G06Q 30/0269
USPC 705/14.66

(57) ABSTRACT

Selecting when to display one of a plurality of advertisements on a digital sign, including receiving information regarding the displaying of advertisements on the digital sign, applying the information to a plurality of advertisement selection rules, and selecting when to display the advertisement on the digital sign in accordance with the advertisement selection rules based on the application of the received information.

### TECHNICAL FIELD

Embodiments of the invention relate to a system for selecting, or targeting, when advertising is to be displayed on a digital display device using data mining.

### BACKGROUND ART

Digital signage is the term that is often used to describe the use of an electronic display device, such as a Liquid Crystal Display (LCD), Light Emitting Diode (LED) display, plasma display, or a projected display to show news, advertisements, local announcements, and other multimedia content in public venues such as restaurants or shopping malls. In recent years, the digital signage industry has experienced tremendous growth, and it is now only second to the Internet advertising industry in terms of annual revenue growth.

Targeted advertising involves selecting the time and location for an advertisement (“ad”) to be displayed to a potential audience member or viewer based on various factors such as demographics, purchase history, or observed viewing behavior. Targeted advertising helps to identify a potential viewer, and improves advertisers' Return on Investment (ROI) by providing timely and relevant advertisement to the potential viewer. Targeted advertising in the digital signage industry involves digital signs that have the capability to dynamically select and play advertisements according to the traits of the potential viewer in front of the digital signs.

What is needed is a way to identify patterns in viewing behavior so that ad content can be targeted and adapted to the specific demographics of the people viewing the ad content.

### BRIEF DESCRIPTION OF THE DRAWINGS

Embodiments of the present invention will be understood more fully from the detailed description given below and from the accompanying drawings of various embodiments of the invention, which, however, should not be taken to limit the invention to the specific embodiments, but are for explanation and understanding only.

FIG. 1 illustrates in functional block form an embodiment of the invention.

FIG. 2 is a flow chart of an embodiment of the invention.

FIG. 3 illustrates aspects of an embodiment of the invention.

FIG. 4 provides a block diagram of a content management system in accordance with an embodiment of the invention.

FIG. 5 provides a block diagram of a digital sign module in accordance with an embodiment of the invention.

FIG. 6 lists tables 1 through 5 referenced below in the description of the embodiments of the invention.

### DESCRIPTION OF THE EMBODIMENTS

Anonymous Video Analytics (AVA) is a passive and automated audience or viewer measurement technology designed for digital signage networks that can be used to provide digital signage operators with quantitative viewership information and return on investment (ROI) data. Embodiments of the present invention use AVA data and data mining techniques to achieve targeted advertising, which can be used to measure and improve the advertising ROI of a digital sign.

Embodiments of the present invention make use of anonymous video analytics (AVA) in displaying advertising on a digital sign comprising a digital display screen or device. By equipping digital signs with a sensor, such as one or more front-facing cameras proximate the digital display device, and AVA software coupled with processors, such as Intel Core 15 and Intel Core 17 processors, digital signs according to an embodiment of the invention have the intelligence to anonymously detect the number of viewers, their gender, and their age bracket, and then adapt ad content based on that information. For example, if a viewer is a teenage girl, then an embodiment of the invention may change the content to highlight a back to school shoe promotion a few stores down from where the digital display screen is presently located. If the viewer is a senior male, then an embodiment may cause the digital display screen to display an advertisement about a golf club sale at a nearby sporting goods store.

According to an embodiment of the invention, ads can be better targeted, more relevant, and ultimately more effective. The embodiment makes this possible by analyzing pixels of video content in real time to determine if people are viewing the digital sign, and if they are, determining their demographic characteristics. By correlating sales data with the ad shown and the audiences' demographics, advertisers can target ads directly to their audience and measure their effectiveness.

Embodiments of the invention involve targeted advertising in which future viewers or customers belonging to the same or similar demographic as previous viewers are targeted based on the viewing behavior or patterns of the previous viewers. By analyzing AVA or viewership data collected from previous viewers positioned in front of a digital display device, embodiments can discover viewing patterns and use this information to train advertising models that can be deployed to the digital sign. These advertising models can then be used to choose specific advertisements from the inventory of available advertising content to intelligently target future viewers with relevant advertisements.

The advertising models utilize data mining techniques and can be built using tools such as Microsoft's SQL Server Analysis System (MS SSAS). The advertising models are created using a well-known data mining algorithm such as Naïve Bayes, Decision Trees, Logistic Regression analysis, and Association Rules, and may also use large scale clustering, all of which are available in MS SSAS.

The playback of multimedia content on a digital sign is accomplished through a content management system (CMS). A description follows of the architecture of a digital sign advertising system in accordance with an embodiment of the invention, in which advertising models are deployed in real time on a digital sign through the CMS, even when the CMS is located “in the cloud”. The CMS can then be used to generate a customized advertising list based on at least two parameters: a trained advertising model, and advertising data. According to an embodiment of the invention, the advertising data is combined with the trained advertising model to enable real-time content triggering.

Embodiments of the invention analyze the type of viewer information, such as age, in particular, an age range or age bracket, and gender, as well as contextual information, such as weather and time information, to select the most appropriate advertisement to be played on the digital sign display device. Further references herein to “age” shall be understood to include an age range, category or bracket. Real time video analytics data is collected and analyzed to predict the type of viewers for a future time slot, for example, the next time slot. In one embodiment, the next time slot is 30 seconds. However, the time slot could be 60 seconds, 30 minutes, one hour, or an even greater length of time. Depending on the prediction, appropriate ads are played on a display device. The CMS generates a default play list by using advertising information and advertiser preference. If viewership information is not available or the prediction is for some reason not made or not reasonably accurate or for some reason the accuracy of the prediction is considered suspect, then an offline (default) play list generated by CMS may be played on the display device.

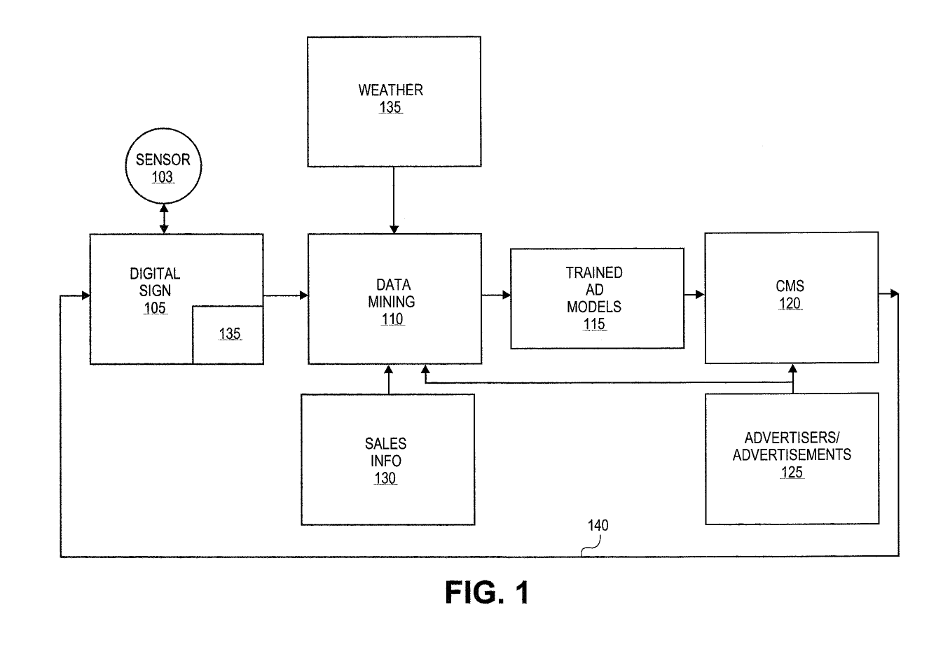

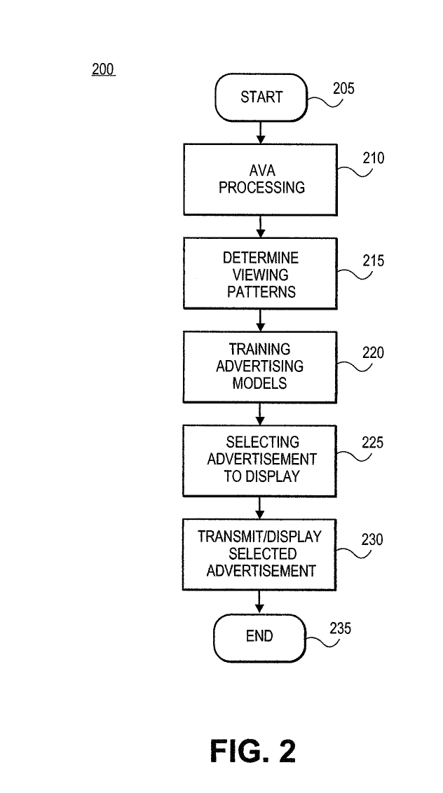

FIG. 1 illustrates a functional block diagram of an embodiment of the invention. With reference also to the flow chart 200 in FIG. 2, the process starts at 205 with digital sign module 105 displaying advertisements, processing anonymous video analytic data at 210, that is, capturing video analytic data, also referred to herein as viewership data, and sending the viewership data to a permanent data store, such as a database, where the data is optionally cleaned or filtered before being accessed at 215 by the data mining module 110 to determine viewing patterns of any individuals located in front of the digital sign and capable of viewing the same.

Importantly, at least for the purpose of maintaining privacy, the video analytic data can be made or maintained as anonymous video analytic data, as will be described further below, but essentially, the viewership data is based on census (defined as systematically and regularly acquiring and recording information about members of a given population), not on sampling, and no images of viewers are captured, stored, or transmitted. The video analytic data capture functionality may be embodied in software executed by the digital sign module, and in one embodiment of the invention, captures real time video analytic data that may be used by data mining module 110 to make real time predictions and schedule a digital advertisement for display, and/or may be used as historical data for generating rules (training advertising models) in the data mining module at 220.

In the data mining module, the advertising models are generated and trained (that is, refined) at 220 using the video analytic data based on well-known data mining algorithms, such as the Naïve Bayes algorithm, the Decision Trees algorithm, Logistic Regression analysis, and the Association Rules algorithm. In addition to using the video analytic data, the data mining module may also consider contextual information such as the weather conditions corresponding at the time the video analytic data was captured. Weather conditions data, or simply, weather data 135, may be maintained in a permanent store that can be accessed by data mining module 110. In one embodiment, the same permanent store may be used to store the video analytic data captured by the digital sign module 105 as well. Further, data mining module 110 receives as input a list of digital advertisements 125 available for display on the digital sign, and metadata associated the list of advertisements, such as the demographic characteristics of viewers to which advertisers wish to target their advertisements. Digital sign module 105 also supplies to the data mining module “proof-of-play” data, that is, advertising data indicating what ads were displayed by the digital sign, when those ads where displayed, and where those ads were displayed (e.g., by providing a device identifier (ID) for the digital sign that can be used as a basis for determining the location of the digital sign). In one embodiment of the invention, sales data 130, for example, from a Point-of-Sale terminal, may be input to data mining module 110. The sales data may be correlated with the AVA data to gauge the effectiveness of an advertisement on a certain demographic group in terms of the sale of products or services featured in the advertisement.

The data mining module 110 generates at 220 trained advertising models which according to an embodiment of the invention are used to predict suitable advertising categories as well as future viewer types based on previous viewer types (“passer pattern types”). Once a trained advertising model 115 is generated it is transmitted by the data mining module and received and stored by the content management system (CMS) 120 where along with advertising data, a customized advertising list is generated and stored at 225. In one embodiment, the CMS stores all trained advertising models, advertisement lists, advertiser preferences, and advertising data. CMS 120 transmits the customized advertising list at 140 to digital sign module 105 for display. In one embodiment of the invention, digital sign module 105 comprises a digital signage media player module (digital player module) 145, which may be used to generate the advertising lists in real time. Module 145 operates as a condensed repository for information stored in the CMS, according to one embodiment of the invention.

The CMS obtains trained advertising models from the data mining module. In one embodiment, multiple digital sign modules 105, or multiple digital signage media players 145, or multiple digital display devices are installed. The CMS therefore will segregate the advertising models by digital sign module, or digital player, etc., as the case may be. The CMS generates segregated customized ad lists based on the advertising models and obtained advertising data. The CMS also generates offline ad lists, that is, default ad lists, based on advertiser preferences obtained from advertisers 125. These segregated models, customized ad lists, and default ad lists are sent to each digital sign module or digital player at 230 for display on the digital sign.

While FIG. 1 illustrates modules 110 and 120 as separate functional blocks, it is appreciated that these modules may co-operate on a single computer system, or may be distributed across multiple computer systems. The computer system(s) may reside in a private communications network, or may be accessible over the Internet “in the cloud”. The digital sign functional block, including AVA software and the digital signage media player 145 is typically implemented in or connected to one or more servers coupled to one or more digital display devices located in an area where advertisers desire to display digital advertisements on a digital sign, such as a retail store or shopping mall. One or more sensors such as sensor 103, for example, an optical device such as a video camera, are coupled to the digital sign module 105 to capture the video or images of viewers used by digital sign module 105 to generate the AVA data. In one embodiment, the digital sign functional block may be implemented in a mobile computing device that may be connected via a wireless communication network with one or more servers. The mobile computing device may include its own sensor, as well as its own digital display device or may be connected via a wireless communication network to one or more digital display devices located in the area where advertisers wish to display digital advertisements.

It is contemplated that multiple digital signs, or multiple digital display screens, may be co-located, for example, in a department store or shopping mall that may be concurrently running distinct or different advertising campaigns. The different departments can deploy the multiple digital signs in adjacent or nearby digital sign zones. The signs and digital advertisements displayed thereon may be hosted by the same or different companies or advertisers, and each zone may want to derive distinct anonymous video analytics for their customers, or distinct data per advertisement per zone. It is also contemplated according to an embodiment of the invention that advertisements may cross multiple zones, for example, in order to measure effectiveness of storewide advertising, such as store branding, special offers, etc.

### Targeted Advertising

The point of targeted advertising is to show a future audience certain advertisements that have, or likely have, in the past been viewed for a reasonable amount of time by a previous audience having the same or similar demographics as the future audience. The process of targeted advertising according to an embodiment of the invention can be characterized in three phases and corresponding components of the digital advertising system according to an embodiment of the invention: learning, or training, advertising models in the data mining module 110, creating customized ad lists, or playlists, in the CMS 120, and playing the playlists with a digital sign module 105.

### A. Learning Advertising Models

Data mining technology involves exploring large amounts of data to find hidden patterns and relationships between different variables in the dataset. These findings can be validated against a new dataset. A typical usage of data mining is to use the discovered pattern in the historical data to make a prediction regarding new data. In embodiments of the invention, the data mining module 110 is responsible for training and querying advertising models. In particular, two types of advertising models are generated, an advertising category (ad category) model, and a passer pattern model. In the ad category model, a set of rules is correlated with the most appropriate ad category for a particular audience or context (e.g., time, location, weather).

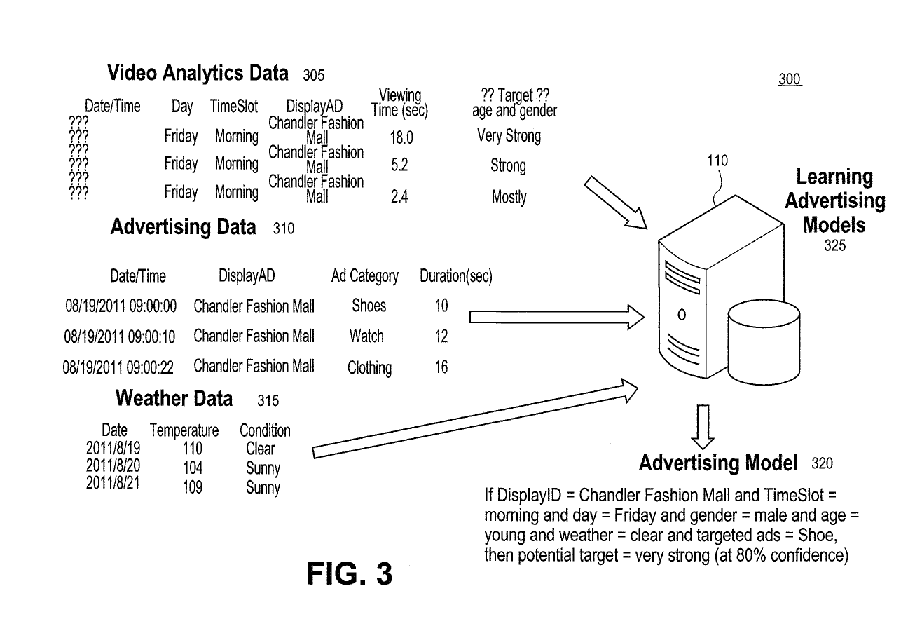

FIG. 3 provides an illustration 300 of the video analytic data 305 gathered by the digital sign module 105 and provided as input to the data mining module 110 along with advertising data 310, and weather data 315 also provided as input to the data mining module. At 325, the data mining module, in one embodiment, generates and trains, that is, refines, models on a regular basis, whether daily, weekly, monthly, or quarterly, depending on the context and data characteristics, the basic principle being that if the patterns/rules derived from historical data don't change, there is no immediate need to train or regenerate models.

Video analytic data 305, according to one embodiment of the invention, comprises the date and time a particular digital advertisement was displayed on the digital sign, as well the day the ad was displayed, a device ID or alternatively a display ID that indicates a location at which the ad was displayed. Sensor input may also provide the amount of time that the digital ad was viewed while being displayed on the digital display device, in one embodiment. Finally, an indication of the potential target viewership based on characteristics such as age and gender is included.

Advertising data 310, received by data mining module 110 from the advertisements repository 125, includes the date and time a particular digital advertisement was scheduled for display on the digital sign, as well a device ID or alternatively a display ID that indicates a location at which the ad was scheduled to be displayed, and a duration or length of the digital advertisement, in seconds. Weather data 315 includes the date, temperature, and conditions on or around the date and time the digital advertising was displayed on the digital sign.

### B. Creating Advertising List

After the advertising models are generated by data mining module 110, the models are transferred to the Content Management System (CMS) 120. The CMS then extracts the ad categories from the ad category models and creates an ad category list. The advertising data corresponding to these ad categories are then retrieved from a permanent store, such as a database, accessible to CMS 120. Based on the ad category list, CMS 120 also creates advertisement lists. In one embodiment of the invention, a generated ad list may be modified based on advertiser input at 125. In one embodiment, each advertiser is assigned a certain priority that can be used as a basis for rearranging the ad list.

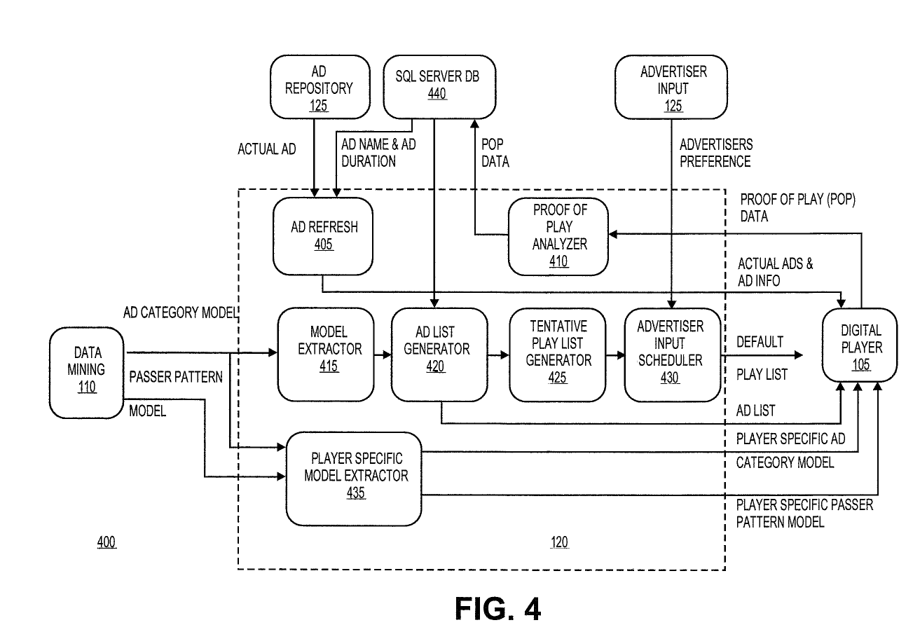

FIG. 4 illustrates the flow of events and information 400 in the CMS 120. The CMS probes the data mining module 110. The frequency of probing in one embodiment of the invention is once a day, according to one embodiment of the invention. The CMS gets all the current rules and predictive lists generated by the data mining module and stores the information in a permanent store. Advertisements corresponding to particular categories are obtained from the tentative playlist based on advertiser preferences, the ad list generator, and advertisement repository 125. In “offline mode” the tentative playlist is used as the default playlist. A data store, such as the Structured Query Language (SQL) server database depicted in FIG. 4, is associated with the advertisements repository 125, according to one embodiment. From that data store various information is retrieved including advertising data for the particular categories such as the advertising name, the advertising type, and a path in a file directory of the ad repository that holds the files for the actual advertisements. The CMS connects to the advertising repository to get the advertisements located at the given paths. All the models and the corresponding advertising lists generated so far get stored at the CMS. A digital sign module typically will only contain a subset of these models and advertising lists that are suitable for the digital sign module's targeted audience. The CMS connects to the digital sign module and pushes to it the models and advertising lists suitable for it.

Referring again to FIG. 4, the Player Specific Model Extractor 435 connects to the data mining module 110, and obtains both the passer pattern type and ad category models. These models are segregated per player and sent to digital sign module (digital player) 105. Data mining module 110 provides models that are suitable for the current day and date as well as the current weather, for example, the current day is Friday Mar. 9, 2012, with a forecasted clear morning and a rainy evening. The model extractor 415 extracts the ad categories from ad category models and sends such to the ad(vertising) list generator 420 for each digital sign. The models are parsed and an advertisement is selected for each time slot. For example, assuming that the average advertisement duration is 10 seconds, 360 advertisements are selected for each hour.

The ad list generator 420 fetches ads for the categories that are scheduled for a particular day, along with the advertising data. The tentative play list generator module analyzes the ad list and generates a tentative play list that is sent to the advertiser input scheduler. Generator 420 compiles a play list based on arranged advertising categories, and an advertising list. The selection of advertisements is based on the roulette-wheel selection, according to one embodiment, where each advertisement is randomly picked based on a probability. The advertiser input scheduler module 420 fetches advertiser input and incorporates advertiser preferences in the tentative play list to generate the default play list which is sent to the digital sign module.

The ad refresh module 405 checks for new advertisements by comparing the versions maintained in a permanent store, e.g., a database, accessible to the CMS against versions obtained from the advertisements repository. If a new version of an advertisement is found then the actual advertisements (video files) are transferred to the digital sign module. If new ads (ads which were not present earlier in the ad repository) are present then module 405 fetches advertising data from SQL server DB 440 and sends such to the digital sign module 105.

### C. Playing Playlist with Digital Sign Module

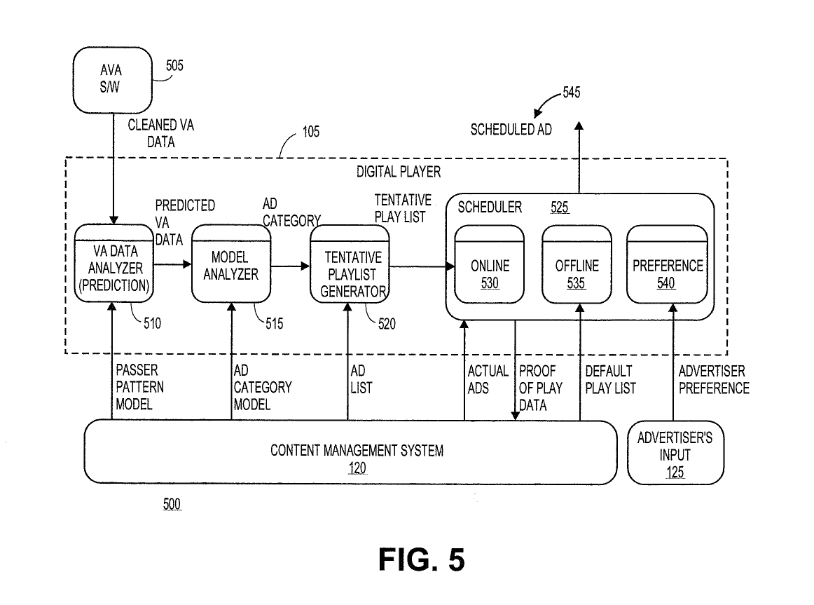

CMS 120 transfers the ad list at 140 to the digital sign module 105. In one embodiment, digital sign module generates a default playlist by extracting file directory path information from the ad list and then retrieving the corresponding advertisements from an advertisements repository 125 that holds the advertisement files. The digital sign module operates in both an online and an offline mode. In the offline mode, the default playlist is played to the digital sign. The playlist for the online mode is generated using the real time VA data described below with reference to FIG. 5 which illustrates the flow of events and information 500 in the digital sign module (digital player) 105.

The video analytic (VA) analyzer (predictor) module 510 fetches real time VA data and retrieves passer pattern models from CMS 120 to predict VA data. The predicted VA data is sent to model analyzer module 515. The model analyzer module 515 receives the predicted VA data as input and retrieves ad category models from CMS 120 and extracts an advertising category based on the predicted VA data. In one embodiment, confidence values of the passer pattern model and the ad category model are multiplied to generate a multiplied confidence value. If the multiplied confidence value is greater than a threshold, then an advertisement for the extracted advertising category is sent to the tentative play list generator 520, otherwise the digital sign module continues in an offline mode. The tentative play list generator module 520 retrieves an advertising list from CMS 120 and generates the tentative play list by considering the advertising category from the model analyzer and sends the tentative play list to online mode.

Scheduler module 525 contains the three sub-modules: an online sub-module that selects an advertisement based on a probability distribution and associates it with an actual advertisement that is then scheduled and sent to display at 545; an offline sub-module that selects an advertisement from a default play list based on the scheduling time and associates it with an actual advertisement that is then scheduled and sent to display at 545; and a preference sub-module that checks for an advertiser preference and schedules an advertiser preferred advertisement for display at 545.

### Real Time Content Triggering

According to an embodiment of the invention, viewers are targeted in real time. The real time processing takes place at the digital sign module. Each digital sign module receives both an advertising category as well as passer pattern models from the CMS. Broadly speaking, according to one embodiment, a plurality of viewers is detected, the demographics of those viewers are analyzed, and viewing patterns for those viewers is collected. Based thereon, advertisements are targeted to the digital sign module. In one embodiment, the passer pattern model has a parameter referred to as the confidence value that indicates whether to play digital advertisements in online mode or offline mode. Thus, when the AVA data is analyzed in real time mode, the rules from the passer pattern model are chosen and the confidence value attached to these rules is compared with a threshold value. If the confidence value falls short of the threshold, then the default playlist is played, but if the value is the same or greater than the threshold, then the advertisements list is modified and advertisements targeting current viewers are played. After the current advertisement is played, either the digital sign module can return to playing the default playlist or could continue playing targeted advertisements.

### Data Mining for Targeted Advertising

Data mining technology involves exploring large amounts of data to find hidden patterns and relationship between different variables in the dataset. Embodiments of the invention use data mining algorithms to discover the patterns on viewing behaviors of the audience. The basic idea is to show a future audience certain ads that have in the past been viewed for a reasonable amount of time by the audience belonging to the same demographics.

### A. Multiple Advertising Model Training

For the purpose of capturing the patterns contained in the viewership data, two embodiments are used to retrain the advertising models: regular retraining and on demand retraining. Regular retraining is triggered regularly, such as weekly or monthly. On-demand retraining is triggered when the performance of the advertising models is lower than a predefined threshold or a retaining request is received from users or operators. In one embodiment, to fully take use of the advantages of different data mining algorithms, multiple data mining algorithms, including Decision Tree, Association Rule and Naïve Bayes, and Logistic Regression analysis are used to train advertising models in parallel. The best advertising model or multiple advertising models is used for ad selection.

### B. Audience Targeting Methods

1. Seeing Based Targeting

Seeing based targeting refers to targeting an audience based on the digital sign “seeing” the audience. Demographic information is obtained from the digital sign's sensor, such as one or more front-facing cameras proximate the digital display device. The sensor, and AVA software coupled with processors provide embodiments to anonymously detect the number of viewers, their gender, and their age bracket, and then adapt ad content based on that information. For example, if three young females and one senior male are seen passing by the digital sign, then the advertising models are queried using this information as input, and the most appropriate ad is selected to play.

2. Prediction Based Targeting

Prediction based targeting first predicts the viewers, or passers, arriving at the digital sign in a future period of time and then targets them. For example, if it is predicted that three young females and one senior male will pass by the digital sign within the next 20 seconds, then an appropriate ad, for example, the most appropriate ad, is selected per the advertising models and prepared to play.

3. Context Based Targeting

Context based targeting targets ads depending on the context, such as date/time, digital sign location, weather information, etc. For example, on a clear Wednesday morning between 9 AM and 11 AM during November and December, an ad for senior males may be selected to play on a particular digital sign according to the advertising models. This embodiment is useful when the passer type prediction based targeting is not reliable or no passer patterns are, or can be, discovered from the viewership data.

### C. Weighted Audience Counting

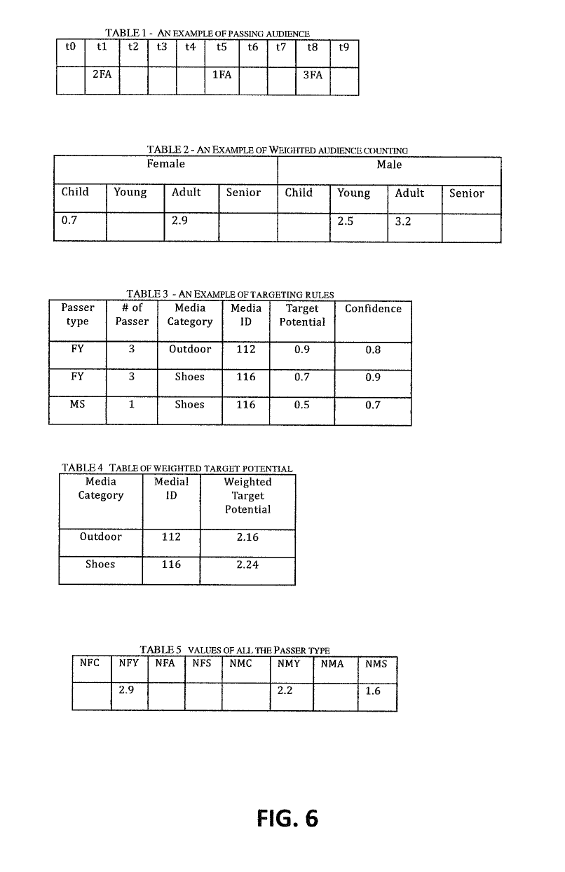

To realize prediction based targeting, a viewer, or passer, prediction model is used to predict the type of viewer, that is, the passer type, in a next time slot. To train this model, weighted audience counting is used to create the training dataset. In one embodiment, the count of each passer type is weighted according to the points in time when that type of passer is expected to pass by the digital sign. For each passer type, the following process is used to calculate its weighted count.
a) Slice time slot, T, into a number of intervals, for example, 10 equal intervals, numbered in this description as intervals t0, t1, t9. In one embodiment, T equals 30 seconds. However, T can be any length of time, for example, T may equal one hour.
b) Label the passer type in a given time slot T with a position P=0, 1, . . . , 9 according to the interval during which the passer type is expected to pass by the digital sign.
c) The weighted count, C, of the passer type is then calculated as

$$C = - {\sum }_{P = 0}^{9} n * ( 1 \frac{P}{10} ) ,$$

where n is the number of passers of this passer type that is expected to pass by the digital sign at position P.
For example, with reference to FIG. 6, table 1 illustrates Female Adults (FA) expected to pass by the digital sign within, or during, time slot T. Two female adults are expected to pass at interval t1, one at interval t5, and three at interval t8.
The weighted count for passer type Female Adult during T is thus

$$C = 2 * ( 1 - \frac{1}{10} ) + 1 * ( 1 - \frac{5}{10} ) + 3 * ( 1 - \frac{8}{10} ) = 2.9 .$$

The above process is repeated for all the passer types in time slot T, creating the dataset for all passer types during time slot T, such as illustrated in FIG. 5, table 2. This process is further repeated for each passer type in each time slot, e.g., time slots T0, T1, . . . , Tn. A training dataset is thus created, which includes many datasets, or rows, one for each time slot, wherein each row provides weighted counts for each passer type. Although the example herein illustrates eight passer types, it is understood that additional, or fewer, passer types may be utilized based on the categories defined in the demographic information.

### D. Passer Prediction Models

According to embodiments of the invention, two types of passer prediction models may be created and utilized as follows.

1. Passer Distribution Prediction Model

Based upon the training dataset as described above with reference to tables 1 and 2 in FIG. 6, specify the passer types (eight in the above example) as predict variables, and train the prediction model accordingly. The trained model specifies the predicted passer type distribution in a next time slot.

2. Dominant Passer Prediction Model

Based upon the above training dataset, select the type of the passer having a maximum count in the dataset as a dominant passer type, and specify the dominant passer type as the predict variable, and train the prediction model accordingly. The trained model indicates the predicted dominant passer type in next time slot. For example, the dominant passer type in table 2 is a Male Adult, whose weighted count has the highest, or maximum, value (3.2), compared to all other passer types in the table.

### E. Advertising Rule Examples

1. Seeing Based Targeting Rules

If device ID=561 and timeslot=morning and day=Friday and gender=female and age=young and weather=clear and IsWeekend=0 and MediaId=10 and MediaCategory=outdoor, then target potential=0.9 (at 80% confidence).

In the above example, mediaID is an identifier for a particular advertisement within the category “outdoor” specified by MediaCategory. Confidence is an indication of the strength of the rule. For example, 80% confidence means that in 8 out of 10 cases, the rule is correct. Target potential indicates the potential interestingness in the particular advertisement. For example, 0.9 (1.0 is the maximum) indicates a very strong interest in the particular advertisement. These rules along with the target potential and confidence values are generated by the data mining module using one or more of the above-referenced data mining algorithms.

2. Prediction Based Targeting Rules

i. Passer Distribution Prediction Rule
If deviceID=561 and time slot=morning and time=11:00˜12:00 and day=Friday and IsWeekend=0 and weather=clear then

NFC=a1*CFC+b1*CFY+c1*CFA+d1*CFS+e1*CMC+f1*CMY+g1*CMA+h1*CMS+i1

NFY=a2*CFC+b2*CFY+c2*CFA+d2*CFS+e2*CMC+f2*CMY+g2*CMA+h2*CMS+i2

NFA=a3*CFC+b3*CFY+c3*CFA+d3*CFS+e3*CMC+f3*CMY+g3*CMA+h3*CMS+i3

NFS=a4*CFC+b4*CFY+c4*CFA+d4*CFS+e4*CMC+f4*CMY+g4*CMA+h4*CMS+i4

NMC=a5*CFC+b5*CFY+c5*CFA+d5*CFS+e5*CMC+f5*CMY+g5*CMA+h5*CMS+i5

NMY=a6*CFC+b6*CFY+c6*CFA+d6*CFS+e6*CMC+f6*CMY+g6*CMA+h6*CMS+i6

NMA=a7*CFC+b7*CFY+c7*CFA+d7*CFS+e7*CMC+f7*CMY+g7*CMA+h7*CMS+i7

NMS=a8*CFC+b8*CFY+c8*CFA+d8*CFS+e8*CMC+f8*CMY+g8*CMA+h8*CMS+i8

where NFC, NFY, NFA, NFS, NMC, NMY, NMA and NMS respectively refer to Next Female Child, Next Female Young, Next Female Adult, Next Female Senior, Next Male Child, Next Male Young, Next Male Adult and Next Male Senior representing the weighted counts of each audience, or passer, type in the Next time slot; and CFC, CFY, CFA, CFS, CMC, CMY, CMA and CMS respectively mean Current Female Child, Current Female Young, Current Female Adult, Current Female Senior, Current Male Child, Current Male Young, Current Male Adult and Current Male Senior representing the weighted counts of each audience type in the Current time slot. The regression coefficients, a1, . . . , a8, b1, . . . , b8, . . . , i1, . . . , i8 are trained by regression algorithms The value of each of the regression coefficients indicates the relevancy of the passer type with which the coefficient is multiplied. For example, in the equation NFC=a1*CFC+b1*CFY+c1*CFA+d1*CFS+e1*CMC+f1*CMY+g1*CMA+h1*CMS+i1, a1 indicates the relevance of the current passer type CFC to the next passer type NFC. In one embodiment, CFC is more relevant than, say, CMS, to NFC, so the value of a1 is greater than the value of h1. In fact, the value of h1 could be zero in one embodiment.

ii. Dominant Passer Prediction Rule
If deviceID=561 and time slot=morning and time=11:00-12:00 and day=Friday and IsWeekend=0 and weather=clear and current dominant passer=senior female then next dominant passer=senior male.

In the above example, the dominant passer type in the current time slot is senior female. The dominant passer type is used as the predict variable provided as input to the dominant passer prediction model. The trained model indicates the predicted dominant passer type in next time slot is senior male.

3. Context Based Targeting Rules
If deviceID=561 and timeslot=morning and time=9:00-9:30 and day=Friday and weather=clear and IsWeekend=0 and MediaId=10 and MediaCategory=Media Category 1, then target potential=0.5 (at 70% confidence).

### F. Advertisement Selection Based on Advertising models

1. Ad Selection for Seeing Based Targeting

According to one embodiment of the invention, the available inputs, e.g., demographic information obtained from viewership data, contextual information, etc., are used to query the seeing based targeting rules. The query identifies the rules set forth in table 3 of FIG. 6. The results of the query are then summarized to create a Weighted Target Potential (WTP) for a particular ad (MediaID), as set forth in table 4 of FIG. 6, wherein WTP=f(# of Passers, Target Potential, Confidence).

For example, assume that three young females and one senior male are seen passing by the digital sign, and the ads within applicable rules are as shown in Table 3 of FIG. 6, namely, ads identified by media IDs 112 and 116. In the example in table 3, the weighted target potential is computed as (# of Passer*Target Potential*Confidence) as shown in Table 4 of FIG. 6. For example, in Media Category “Outdoor”, Media ID 112, the weighted target potential (WTP) is calculated as 3 (the number of FY passer types in row 1 of table 3) multiplied by 0.9 (Target Potential in row 1 of table 3) multiplied by 0.8 (Confidence in row 1 of table 3)=2.16. Further, the WTP for Media Category “Shoes”, medial ID 116, is calculated as (3*0.7*0.9)+(1*0.5*0.7)=2.24, given the values present in rows 2 and 3 of table 3.

According to one embodiment, the list of ads in Table 4 may be ranked based on the Weighted Target Potential (WTP) for each ad, and the top m ads, in terms of WTP, are selected as the recommended ads. In one embodiment, the top m ads are selected by further considering other factors, such as an advertiser's input, to finalize the final ads to play.

2. Ad Selection for Prediction Based Targeting

Regarding passer distribution prediction, according to one embodiment, the weighted counts of all the passer types in the current time slot, namely, CFC, CFY, CFA, CFS, CMC, CMY, CMA, CMS, in the above examples, are calculated. These weighted counts are then provided along with other available inputs, e.g., contextual information, to the passer distribution prediction model, which then calculates the weighted counts for corresponding passer types in a next time slot, namely, NFC, NFY, NFA, NFS, NMC, NMY, NMA, NMS, using the prediction based targeting rules. An example of the weighted counts for the corresponding passer types in the next time slot is illustrated in FIG. 6, table 5.

These weighted counts associated with respective passer types in a next time slot are summarized to create a Weighted Target Potential (WTP) for a particular ad (MediaID), similar to the summary for seeing based targeting rules as illustrated in table 4, except that WTP in this case=f(weighted counts for the corresponding passer types in the next time slot, Target Potential, Confidence). Essentially, the difference between the seeing based targeting rules and the passer distribution prediction targeting rules is that the actual number of passers used in the seeing based targeting rules is replaced with the weighted counts for the corresponding predicted passer types in the next time slot in passer distribution prediction based targeting rules.

According to one embodiment, the list of ads created using the passer distribution prediction model can be ranked based on the Weighted Target Potential (WTP) for each ad. The top m ads, in terms of WTP, are selected as the recommended ads. In one embodiment, the top m ads are selected by further considering other factors, such as an advertiser's input, to finalize the final ads to play.

Regarding dominant passer prediction, after calculating the weighted counts of all the passer types in the current time slot, CFC, CFY, CFA, CFS, CMC, CMY, CMA, CMS, an embodiment of the invention then selects and provides as input the Current Dominant Passer type and other available inputs to the dominant passer prediction model, which generates the Next Dominant Passer type. Since only one (the dominant) passer type is considered, the number (#) of passers for the dominant passer type is not used for this calculation.

Regarding context based prediction, context information (time, location, weather) is provided as input to query context based targeting rules which generate therefrom a list of ads with corresponding Target Potential and Confidence values. This list may be ranked based on the Target Potential for each ad, and the top m ads are selected as the recommended ads. In one embodiment, the top m ads are selected by further considering other factors, such as an advertiser's input, to finalize the ads selected to play.

The following examples pertain to further embodiments.

A method of selecting when to display one of a plurality of advertisements on a digital sign, comprising receiving information regarding the displaying of advertisements on the digital sign; applying the information to a plurality of advertisement selection rules; and selecting when to display the one advertisement on the digital sign in accordance with the advertisement selection rules based on the application of the received information. In one embodiment the method of receiving information comprises receiving demographic information regarding actual viewers of previous advertisements displayed on the digital sign. In one embodiment, applying the information to a plurality of advertisement selection rules comprises applying the received demographic information regarding actual viewers of previous advertisements to a plurality of seeing based advertisement selection rules.

In one embodiment, applying the received demographic information regarding actual viewers of previous advertisements to a plurality of seeing based advertisement selection rules generates a weighted list of the plurality of advertisements. In one embodiment, selecting when to display the one advertisement comprises selecting the one advertisement from the weighted list.

In one embodiment, receiving information comprises receiving demographic information regarding predicted viewers of advertisements to be displayed on the digital sign. Applying the information to a plurality of advertisement selection rules comprises applying the received demographic information regarding predicted viewers of future advertisements to a plurality of prediction based advertisement selection rules. Applying the received demographic information regarding predicted viewers of future advertisements to a plurality of prediction based advertisement selection rules generates a weighted list of the plurality of advertisements. Selecting when to display the one advertisement comprises selecting the one advertisement from the weighted list.

In one embodiment, receiving information comprises receiving contextual information regarding the displaying of advertisements on the digital sign. Applying the information to a plurality of advertisement selection rules comprises applying the received contextual information regarding the displaying of advertisements on the digital sign to a plurality of contextual based advertisement selection rules. Applying the received contextual information generates a weighted list of the plurality of advertisements. Selecting when to display the one advertisement comprises selecting from the weighted list an advertisement having the greatest weight as the one advertisement.

In one embodiment, an apparatus to select when to display one of a plurality of advertisements on a digital sign, comprises: a data mining module to couple to the digital sign to receive information regarding the displaying of advertisements on the digital sign; the data mining module to apply the information to a plurality of advertisement selection rules; and a content management system coupled to the data mining module to select when to display the one advertisement on the digital sign in accordance with the advertisement selection rules based on the application of the received information.

In one embodiment, the data mining module to receive information comprises the data mining module to receive demographic information regarding actual viewers of previous advertisements displayed on the digital sign. In one embodiment, the data mining module to apply the information to a plurality of advertisement selection rules comprises the data mining module to apply the received demographic information regarding actual viewers of previous advertisements to a plurality of seeing based advertisement selection rules. In one embodiment, the data mining module to apply the received demographic information regarding actual viewers of previous advertisements to a plurality of seeing based advertisement selection rules generates a weighted list of the plurality of advertisements. According to one embodiment, the content management system to select when to display the one advertisement comprises the content management system to select the one advertisement from the weighted list.

According to one embodiment, the data mining module to receive information comprises the data mining module to receive demographic information regarding predicted viewers of advertisements to be displayed on the digital sign, and wherein the data mining module to apply the information to a plurality of advertisement selection rules comprises the data mining module to apply the received demographic information regarding predicted viewers of future advertisements to a plurality of prediction based advertisement selection rules. In one embodiment, the data mining module to apply the received demographic information regarding predicted viewers of future advertisements to a plurality of prediction based advertisement selection rules generates a weighted list of the plurality of advertisements, and wherein the content management system to select when to display the one advertisement comprises the content management system to select the one advertisement from the weighted list.

According to one embodiment, the data mining module to receive information comprises the data mining module to receive contextual information regarding the displaying of advertisements on the digital sign, and wherein the data mining module to apply the information to a plurality of advertisement selection rules comprises the data mining module to apply the received contextual information regarding the displaying of advertisements on the digital sign to a plurality of contextual based advertisement selection rules. The data mining module to apply the received contextual information generates a weighted list of the plurality of advertisements, and wherein the content management system to select when to display the one advertisement comprises the content management system to select from the weighted list an advertisement having a weight such that the advertisement is selected as the one advertisement.

According to one embodiment, a method of selecting when to display one of a plurality of advertisements on a digital sign is performed, comprising receiving information regarding the displaying of advertisements on the digital sign, applying the information to a plurality of advertisement selection rules, and selecting when to display the one advertisement, for example, from a weighted list, on the digital sign in accordance with the advertisement selection rules based on the application of the received information. According to one embodiment, receiving the information regarding the display comprises receiving demographic information regarding actual viewers of previous advertisements displayed on the digital sign. According to one embodiment, applying the information to a plurality of advertisement selection rules comprises applying the received demographic information regarding actual viewers of previous advertisements to a plurality of seeing based advertisement selection rules. In one embodiment, applying the received demographic information regarding actual viewers of previous advertisements to a plurality of seeing based advertisement selection rules generates a weighted list of the plurality of advertisements.

In one embodiment, receiving information regarding the displaying of advertisements on the digital sign comprises receiving demographic information regarding predicted viewers of advertisements to be displayed on the digital sign. Further, in this embodiment, applying the information to a plurality of advertisement selection rules comprises applying the received demographic information regarding predicted viewers of future advertisements to a plurality of prediction based advertisement selection rules. Additionally, in this embodiment, applying the received demographic information regarding predicted viewers of future advertisements to a plurality of prediction based advertisement selection rules generates a weighted list of the plurality of advertisements. According to the embodiment, selecting when to display the one advertisement comprises selecting the one advertisement from the weighted list.

In one embodiment, receiving the information comprises receiving contextual information regarding the displaying of advertisements on the digital sign. In such an embodiment, applying the information to a plurality of advertisement selection rules comprises applying the received contextual information regarding the displaying of advertisements on the digital sign to a plurality of contextual based advertisement selection rules. In the embodiment, applying the received contextual information may generate a weighted list of the plurality of advertisements. In the embodiment, selecting when to display the one advertisement comprises selecting from the weighted list an advertisement having the greatest weight as the one advertisement.

It is appreciated that the above embodiments can be implemented in software such that at least one machine readable medium comprises a plurality of instructions that in response to being executed on a computing device, cause the computing device to perform the above embodiments.

In one embodiment, an apparatus selects when to display one of a plurality of advertisements on a digital sign. The apparatus comprises a data mining module to couple to the digital sign to receive information regarding the displaying of advertisements on the digital sign. The data mining module applies the information to a plurality of advertisement selection rules. A content management system coupled to the data mining module selects when to display the one advertisement on the digital sign in accordance with the advertisement selection rules based on the application of the received information.

In one embodiment, the data mining module receives demographic information regarding actual viewers of previous advertisements displayed on the digital sign, and applies the received demographic information regarding actual viewers of previous advertisements to a plurality of seeing based advertisement selection rules. This may be accomplished by the data mining module generating a weighted list of the plurality of advertisements. In one embodiment, the content management system selects the one advertisement from the weighted list.

In one embodiment, the data mining module receives demographic information regarding predicted viewers of advertisements to be displayed on the digital sign, and applies the received demographic information regarding predicted viewers of future advertisements to a plurality of prediction based advertisement selection rules. In one embodiment, the data mining module may generate a weighted list of the plurality of advertisements, and the content management system then selects the one advertisement from the weighted list.

In one embodiment, the data mining module receives contextual information regarding the displaying of advertisements on the digital sign, and applies the received contextual information regarding the displaying of advertisements on the digital sign to a plurality of contextual based advertisement selection rules. In one embodiment, the data mining module may generate a weighted list of the plurality of advertisements, and the content management system selects from the weighted list an advertisement having a weight such that the advertisement is selected as the one advertisement.

### Conclusion

In this description, numerous details have been set forth to provide a more thorough explanation of embodiments of the present invention. It should be apparent, however, to one skilled in the art, that embodiments of the present invention may be practiced without these specific details. In other instances, well-known structures and devices have been shown in block diagram form, rather than in detail, in order to avoid obscuring embodiments of the present invention.

Some portions of this detailed description are presented in terms of algorithms and symbolic representations of operations on data within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise, as apparent from this discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

Embodiments of present invention also relate to apparatuses for performing the operations herein. Some apparatuses may be specially constructed for the required purposes, or it may comprise a general purpose computer selectively activated or reconfigured by a computer program stored in the computer. Such a computer program may be stored in a computer readable storage medium, such as, but not limited to, any type of disk including floppy disks, optical disks, CD-ROMs, DVD-ROMs, and magnetic-optical disks, read-only memories (ROMs), random access memories (RAMs), EPROMs, EEPROMs, NVRAMs, magnetic or optical cards, or any type of media suitable for storing electronic instructions, and each coupled to a computer system bus.

The algorithms and displays presented herein are not inherently related to any particular computer or other apparatus. Various general purpose systems may be used with programs in accordance with the teachings herein, or it may prove convenient to construct more specialized apparatus to perform the required method steps. The required structure for a variety of these systems appear from the description herein. In addition, embodiments of the present invention are not described with reference to any particular programming language. It will be appreciated that a variety of programming languages may be used to implement the teachings of the invention as described herein.

A machine-readable medium includes any mechanism for storing or transmitting information in a form readable by a machine (e.g., a computer). For example, a machine-readable medium includes read only memory (“ROM”); random access memory (“RAM”); magnetic disk storage media; optical storage media; flash memory devices; etc.

Whereas many alterations and modifications of the embodiment of the present invention will no doubt become apparent to a person of ordinary skill in the art after having read the foregoing description, it is to be understood that any particular embodiment shown and described by way of illustration is in no way intended to be considered limiting. Therefore, references to details of various embodiments are not intended to limit the scope of the claims that recite only those features regarded as essential to the invention.

1. A method of selecting when to display one of a plurality of advertisements on a digital sign, comprising:
receiving information regarding the displaying of advertisements on the digital sign;
applying the information to a plurality of advertisement selection rules; and
selecting when to display the one advertisement on the digital sign in accordance with the advertisement selection rules based on the application of the received information.

2. The method of claim 1, wherein receiving information comprises receiving demographic information regarding actual viewers of previous advertisements displayed on the digital sign.

3. The method of claim 2, wherein applying the information to a plurality of advertisement selection rules comprises applying the received demographic information regarding actual viewers of previous advertisements to a plurality of seeing based advertisement selection rules.

4. The method of claim 3, wherein applying the received demographic information regarding actual viewers of previous advertisements to a plurality of seeing based advertisement selection rules generates a weighted list of the plurality of advertisements.

5. The method of claim 4, wherein selecting when to display the one advertisement comprises selecting the one advertisement from the weighted list.

6. The method of claim 1, wherein receiving information comprises receiving demographic information regarding predicted viewers of advertisements to be displayed on the digital sign.

7. The method of claim 6, wherein applying the information to a plurality of advertisement selection rules comprises applying the received demographic information regarding predicted viewers of future advertisements to a plurality of prediction based advertisement selection rules.

8. The method of claim 7, wherein applying the received demographic information regarding predicted viewers of future advertisements to a plurality of prediction based advertisement selection rules generates a weighted list of the plurality of advertisements.

9. The method of claim 8, wherein selecting when to display the one advertisement comprises selecting the one advertisement from the weighted list.

10. The method of claim 1, wherein receiving information comprises receiving contextual information regarding the displaying of advertisements on the digital sign.

11. The method of claim 10, wherein applying the information to a plurality of advertisement selection rules comprises applying the received contextual information regarding the displaying of advertisements on the digital sign to a plurality of contextual based advertisement selection rules.

12. The method of claim 11, wherein applying the received contextual information generates a weighted list of the plurality of advertisements.

13. The method of claim 12, wherein selecting when to display the one advertisement comprises selecting from the weighted list an advertisement having the greatest weight as the one advertisement.

14. At least one machine readable medium comprising a plurality of instructions that in response to being executed on a computing device, cause the computing device to:
receive information regarding the displaying of advertisements on a digital sign;
apply the information to a plurality of advertisement selection rules; and
select when to display the one advertisement on the digital sign in accordance with the advertisement selection rules based on the application of the received information.

15. The at least one machine readable medium of claim 14, wherein to receive information comprises to receive demographic information regarding actual viewers of previous advertisements displayed on the digital sign, and wherein to apply the information to a plurality of advertisement selection rules comprises to apply the received demographic information regarding actual viewers of previous advertisements to a plurality of seeing based advertisement selection rules.

16. The at least one machine readable medium of claim 15, wherein to apply the received demographic information regarding actual viewers of previous advertisements to a plurality of seeing based advertisement selection rules generates a weighted list of the plurality of advertisements, and wherein to select when to display the one advertisement comprises to select from the weighted list an advertisement based on its weight as the one advertisement.

17. The at least one machine readable medium of claim 14, wherein to receive information comprises to receive demographic information regarding predicted viewers of advertisements to be displayed on the digital sign, and wherein to apply the information to a plurality of advertisement selection rules comprises to apply the received demographic information regarding predicted viewers of future advertisements to a plurality of prediction based advertisement selection rules.

18. The at least one machine readable medium of claim 17, wherein to apply the received demographic information regarding predicted viewers of future advertisements to a plurality of prediction based advertisement selection rules generates a weighted list of the plurality of advertisements, and wherein to select when to display the one advertisement comprises to select an advertisement from the weighted list as the one advertisement based on a corresponding weight for the advertisement.

19. The at least one machine readable medium of claim 14, wherein to receive information comprises to receive contextual information regarding the displaying of advertisements on the digital sign, and wherein to apply the information to a plurality of advertisement selection rules comprises to apply the received contextual information regarding the displaying of advertisements on the digital sign to a plurality of contextual based advertisement selection rules.

20. The at least one machine readable medium of claim 19, wherein to apply the received contextual information generates a weighted list of the plurality of advertisements, and wherein to select when to display the one advertisement comprises to select from the weighted list an advertisement having a particular weight as the one advertisement.

21. An apparatus to select when to display one of a plurality of advertisements on a digital sign, comprising:
a data mining module to couple to the digital sign to receive information regarding the displaying of advertisements on the digital sign;
the data mining module to apply the information to a plurality of advertisement selection rules; and
a content management system coupled to the data mining module to select when to display the one advertisement on the digital sign in accordance with the advertisement selection rules based on the application of the received information.

22. The apparatus of claim 21, wherein the data mining module to receive information comprises the data mining module to receive demographic information regarding actual viewers of previous advertisements displayed on the digital sign.

23. The apparatus of claim 22, wherein the data mining module to apply the information to a plurality of advertisement selection rules comprises the data mining module to apply the received demographic information regarding actual viewers of previous advertisements to a plurality of seeing based advertisement selection rules.

24. The apparatus of claim 23, wherein the data mining module to apply the received demographic information regarding actual viewers of previous advertisements to a plurality of seeing based advertisement selection rules generates a weighted list of the plurality of advertisements.

25. The apparatus of claim 24, wherein the content management system to select when to display the one advertisement comprises the content management system to select the one advertisement from the weighted list.

26. The apparatus of claim 21, wherein the data mining module to receive information comprises the data mining module to receive demographic information regarding predicted viewers of advertisements to be displayed on the digital sign, and wherein the data mining module to apply the information to a plurality of advertisement selection rules comprises the data mining module to apply the received demographic information regarding predicted viewers of future advertisements to a plurality of prediction based advertisement selection rules.

27. The apparatus of claim 26, wherein the data mining module to apply the received demographic information regarding predicted viewers of future advertisements to a plurality of prediction based advertisement selection rules generates a weighted list of the plurality of advertisements, and wherein the content management system to select when to display the one advertisement comprises the content management system to select the one advertisement from the weighted list.

28. The apparatus of claim 21, wherein the data mining module to receive information comprises the data mining module to receive contextual information regarding the displaying of advertisements on the digital sign, and wherein the data mining module to apply the information to a plurality of advertisement selection rules comprises the data mining module to apply the received contextual information regarding the displaying of advertisements on the digital sign to a plurality of contextual based advertisement selection rules.

29. The apparatus of claim 28, wherein the data mining module to apply the received contextual information generates a weighted list of the plurality of advertisements, and wherein the content management system to select when to display the one advertisement comprises the content management system to select from the weighted list an advertisement having a weight such that the advertisement is selected as the one advertisement.
